(19) United States
(12) Patent Application Publication
(10) Pub. No.: US 2003/0009516 A1
(43) Pub. Date: Jan. 9, 2003

(54) Box for writing instruments

(76) Inventors: James A. McGillivray, Stroudsburg, PA (US); Bernard J. Kocon, Bethlehem, PA (US)

Correspondence Address: LEYDIG VOIT & MAYER, LTD, TWO PRUDENTIAL PLAZA, SUITE 4900, 180 NORTH STETSON AVENUE, CHICAGO, IL, 60601-6780, US

(21) Appl. No.: 09/898,827

(22) Filed: Jul. 3, 2001

(51) Int. Cl. G06F 15/16

(52) U.S. Cl. 709/203

(57) ABSTRACT

A box for directly displaying a particular attribute of a writing instrument packaged within the box. The box includes a front panel and an opening adjacent the top or bottom edge of the front panel. The box is constructed of a sheet of foldable material, which is pre-scored to define fold lines and sealing flaps that are glued or otherwise fastened to other parts of the sheet to form the box.

### FIELD OF THE INVENTION

The invention generally relates to enclosures for writing instruments. More specifically, the invention relates to a box for writing instruments that facilitates direct display of particular attributes of the writing instruments packaged within the box.

### BACKGROUND OF THE INVENTION

Although highly effective as enclosures, boxes constructed of non-transparent materials constitute a physical and visual barrier between consumers and the items packaged within. A basic function of such a box is to package individual items or groups of items for transportation and retailing. However, boxes constructed of opaque materials such as cardboard, paperboard, and the like, otherwise ideal for packaging, prevent manufacturers and retailers from directly displaying desirable, innovative attributes of the packaged items to consumers. As a result, manufacturers and retailers are limited to written descriptions or graphic depictions of the product on the outside of such a box.

Such written descriptions or graphic depictions, however, are subject to the limitations of the English language and to variations in the quality of the photography or artwork. For example, last-minute changes to a product's attributes before packaging could lead to an inaccurate description or depiction on its packaging that has not been updated to reflect the changes. A much more effective and direct method of displaying the product, while maintaining the inherent advantages of box packaging, would better serve the interests of manufacturers and consumers. Specifically, a mechanism for displaying the actual product contained within the box directly to the consumer would avoid the problems of mispackaging or misdescribing the product on the outside of a box. Providing direct visibility of the product within an enclosure affords manufacturers a chance to show desirable and innovative features directly to customers. As a result, consumers are instilled with confidence and manufacturers stand to garner a significant advantage over competitor's products completely hidden from view by their packaging.

Moreover, a box designed for direct visibility of the items within retains sturdiness and other advantages of a traditional opaque enclosure box. For example, traditional boxes stack and pack better than other flexible-type enclosures. A box constructed of folded sheet material also tends to retain its shape better than other materials. Further, the material used for such boxes can often be recycled, thus reducing waste of natural resources, preventing litter, and possibly reducing the cost of the materials used. A box design incorporating direct visibility of the items within thus achieves a significant advantage over conventional boxes, without sacrificing the benefits of conventional boxes.

It would also be desirable to provide a box with some flexibility in the use of the direct product-viewing capability. A design that allows simple and easy variation of the product-viewing capability, while retaining the printed scheme of the box, would allow manufacturers or retailers to use the same box across various product lines. It would be further advantageous for such a box design to directly display innovative features located in different positions along the products within, without the need to redesign exterior graphics. Thus, a box design that retains the benefits of conventional boxes constructed of a folded sheet of material and allows direct display of the product within is desirable.

### BRIEF SUMMARY OF THE INVENTION

Accordingly, the present invention provides a box for writing devices with substantially improved features over conventional opaque enclosures while exploiting their positive characteristics. According to one exemplary embodiment, the invention takes the form of a box for writing instruments with a die cut opening in the front face thereof. The opening may be located near the top or near the bottom of the front face of the enclosure, so as to directly display particular attributes near the ends of the writing instruments contained therein. Such attributes may include an eraser, an innovative marker nib visible through a clear cap, a toy or novelty on the end of a crayon, marker or pencil, a chemical reservoir for erasability or a unique writing technique.

These and other advantages of the present invention, as well as additional inventive features, will be apparent from the description of the invention provided herein.

### BRIEF DESCRIPTION OF THE DRAWINGS

FIG. 1 is a perspective view of an exemplary embodiment of the invention, illustrating a die cut opening in the shape of a semicircle disposed near the bottom of the front panel.

FIG. 2 is a sectional view of the embodiment of the invention illustrated in FIG. 1, taken along line 2-2, and further illustrating the arrangement of writing instruments within.

FIG. 3 is a plan view of a die cut sheet of material from which an embodiment of the invention is constructed.

FIG. 4 is a plan view of a die cut sheet of material from which another embodiment of the present invention is constructed.

FIG. 5 is a perspective view of another embodiment of the invention, illustrating the die cut opening in the shape of a trapezoid disposed near the bottom of the front panel.

FIG. 6 is a perspective view of another embodiment of the invention, illustrating the die cut opening in the shape of a hexagon disposed near the bottom of the front panel.

FIG. 7 is a perspective view of another embodiment of the invention, illustrating the die cut opening in the shape of a semicircle disposed near the top of the front panel.

FIG. 8 is a perspective view of another embodiment of the invention, illustrating the die cut opening in the shape of a truncated semicircle disposed near the bottom of the front panel.

FIG. 9 is a perspective view of another embodiment of the invention, illustrating an obround die cut opening disposed near the bottom of the front panel.

FIG. 10 is a perspective view of another embodiment of the invention, illustrating a wave-shaped die cut opening disposed near the bottom of the front panel.

FIG. 11 is a perspective view of another embodiment of the invention, illustrating a semicircular die cut opening disposed a particular distance from the top edge of the front panel.

FIG. 12 is a perspective view of another embodiment of the invention, illustrating a semicircular die cut opening disposed a particular distance from the bottom edge of the front panel.

FIG. 13 is an end view of another embodiment of the invention, illustrating the embodiment's capacity for additional rows of writing instruments.

FIG. 14 is a perspective view of a writing instrument, with an attribute, to be contained within the present invention.

FIG. 15 is an elevational view of another writing instrument, with an attribute, to be contained within the present invention.

FIG. 16 is a perspective view of another embodiment of the invention, illustrating another writing instrument, with an attribute directly visible through the die cut opening near the top edge of the front panel.

### DETAILED DESCRIPTION OF THE INVENTION

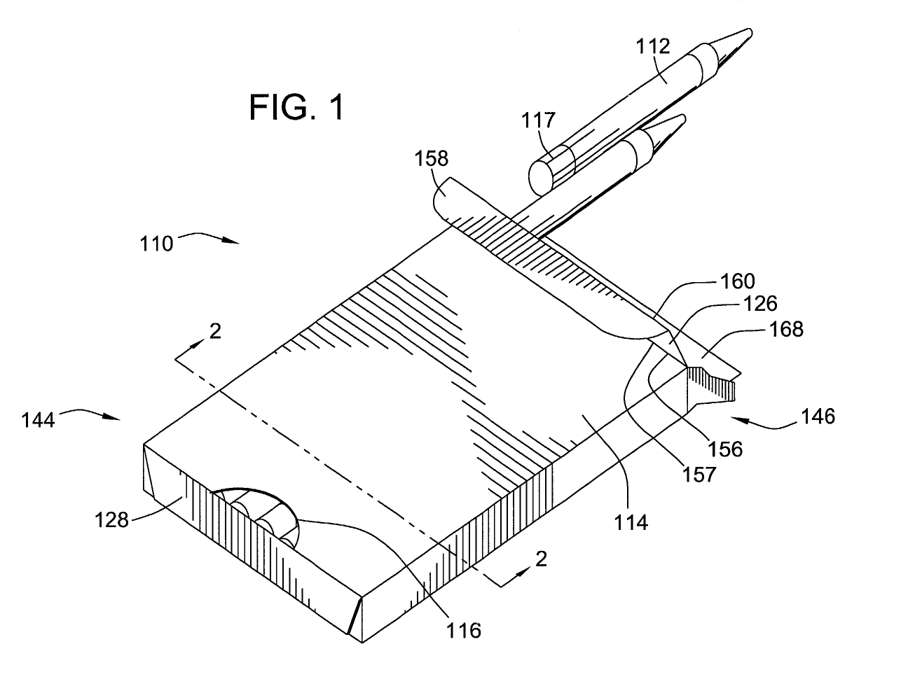

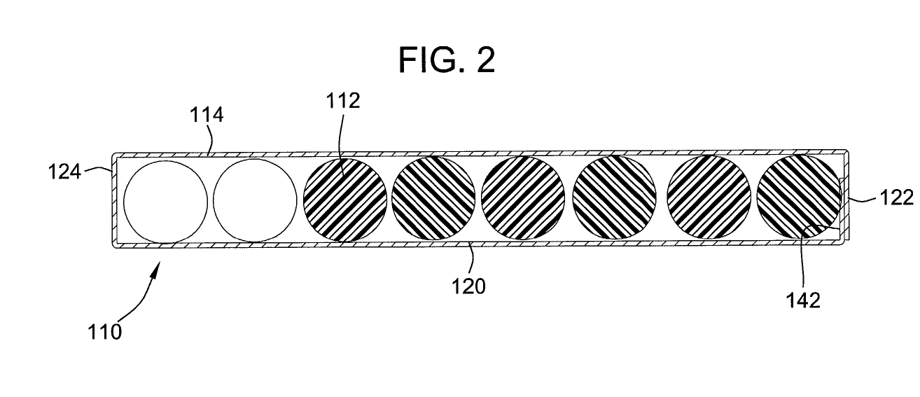

Turning now to the drawings, FIGS. 1 and 2 illustrate an exemplary embodiment of the invention. A box 110 is shown, for packaging writing instruments, of which writing instrument 112 is representative. The writing instruments enclosed in the box 110 may be similar or different, and nothing in this specification should be construed as limiting the type of writing instrument stored within the box 110 to any particular embodiment. For example, the writing instruments may be markers, crayons, pencils, or the like. The size and shape of the box 110 may also be tailored to fit any type or quantity of writing instruments, whether individual instruments, or a group thereof. The box 110 further includes a front panel 114 with a die cut opening 116 that affords direct display of an attribute 117 of a writing instrument 112 contained within.

As described above, directly displaying a particular attribute 117 of a writing instrument 112 contained within the box 110 benefits the manufacturer, retailer, and the consumer or end user. By providing a direct display, the manufacturer instills confidence in the consumer as to the actual contents of the box. It is also a way for a manufacturer to feature new and innovative attributes of products, and to reduce costs by using the same or slightly modified packaging across product lines. That is, a written or graphical description on the outside of the box 110 is superfluous to an opening directly displaying the product. This allows a manufacturer to feature a particular tradename or trade dress on his packaging, common to multiple product lines, while permitting the consumer or end user to directly view and differentiate the contents.

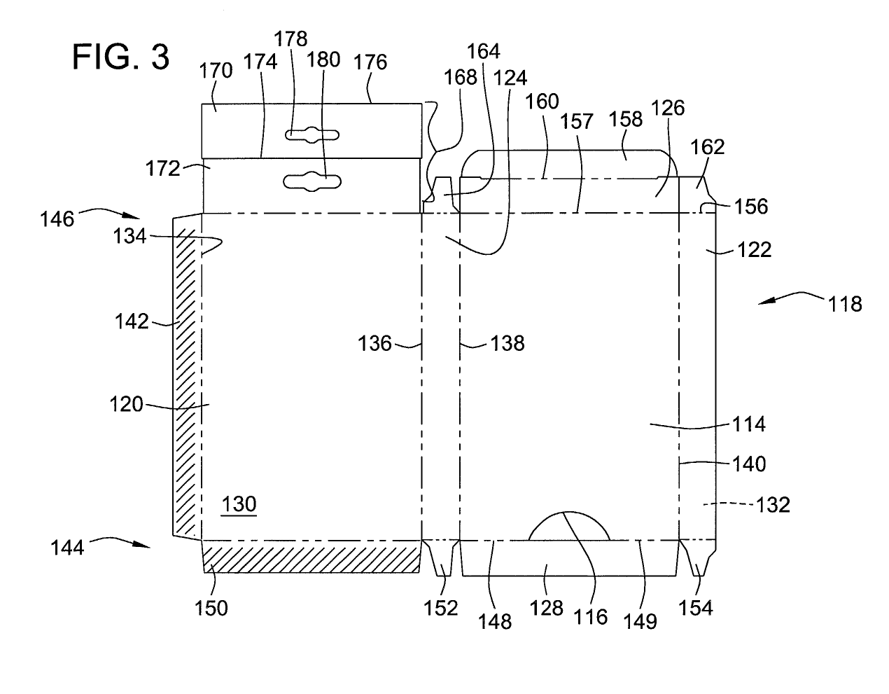

As shown in FIG. 3, the size and shape of the box 110 is determined by the configuration of a die cut sheet 118 of material. The sheet 118 can easily be precut to include multiple flaps that facilitate construction of the box 110. In this exemplary embodiment, the die cut sheet 118 includes a front panel 114, a semicircular die cut opening 116, a back panel 120, a left side panel 122, a right side panel 124, a top panel 126, and a bottom panel 128. It is to be noted that the die cut opening is not limited by the spirit or teachings of the invention to any particular shape. To the contrary, embodiments including die cut openings of various shapes are contemplated within the scope of the invention, as will be described below.

The die cut sheet 118 also includes a print side 130 and a back side 132. Longitudinal score lines 134, 136, 138, 140 define a longitudinal sealing flap 142, the left side panel 122, the right side panel 124, and the front panel 114. The box 110 is constructed by folding the longitudinal sealing flap 142, the back panel 120, the right side panel 124, and the left side panel 122 along longitudinal score lines 134, 136, 138, 140 such that adjacent panels are oriented normally to each other and so that the back side 132 is to the interior of each right angle formed. Accordingly, the print side 130 will be to the exterior of each right angle formed. When the panels are thus folded, the longitudinal sealing flap 142 will tend to abut the left side panel 122, forming a sleeve with a bottom end 144 and a top end 146, as best seen in FIGS. 1 and 2. To secure the panels in this configuration, the print side 130 of the longitudinal sealing flap 142 is fastened to the back side 132 of left side panel 122. The flap 142 and left side panel 122 may be fastened by glue or other fastening means, not limited to the particular embodiments described in this specification.

As shown in FIG. 3, a transverse score line 148 defines a transverse sealing flap 150 and lower locking tabs 152, 154. Moreover, the transverse score line 148 also defines a bottom edge 149 of the front panel 114 when the bottom panel 128 is folded in the fashion described above. As illustrated in the exemplary embodiment, the die cut opening 116 may be disposed on the front panel 114 adjacent the bottom edge 149. In this embodiment, the opening is on the bottom edge 149. In other embodiments, the opening may be near the edge. To close the bottom end 144, the transverse sealing flap 150 is fastened to the bottom panel 128 in a similar fashion as the longitudinal sealing flap 142. However, before folding and fastening, lower locking tabs 152, 154 are folded along transverse score line 148 toward the interior of the box 110, such that they are inside of the transverse sealing flap 150 when it is fastened to the bottom panel 128. Thus, the bottom 144 of the box 110 is fastened at the bottom panel 128 and the left side panel 122.

To facilitate closing of the top end 146, a top panel 126 of the box 110 is defined by transverse score line 156, as seen in FIGS. 1 and 3. The top panel 126 further includes a locking flap 158 and a transverse score line 160. To close the box, upper locking tabs 162, 164 are first folded along transverse score line 156, toward the interior of the box 110. Then, the top panel 126 and locking flap 158 are folded toward the interior of the box 110 along the transverse score lines 156, 160 respectively. Moreover, a top edge 157 of the front panel 114 is defined by a score line 156 when the top panel 126 is folded in this fashion. The locking flap 158 is then inserted into the box 110, and is held closed by upper locking tabs 162, 164 and by abutting the back side 132 of the back panel 120.

Thus, a box 110 is formed for packaging writing instruments. Such a box 110, formed out of a die cut sheet 118, offers certain advantages common to conventional box designs, including sturdiness and ease of packing or stacking multiple boxes 110 in a relatively small amount of space. Further, the manufacture of the box 110 is simple and economical. Recycled construction materials may be utilized, potentially reducing the cost of new material and benefiting the environment. Moreover, the die cut method of manufacture, although certainly not the exclusive mode of manufacture, makes all cuts precisely and repeatably, thus reducing raw material waste.

To hang and display the box 110, the exemplary embodiment may include a hanging flap 168, which is formed by a front hanging panel 170 and a rear hanging panel 172. The front hanging panel 170 is separated from the rear hanging panel 172 by a transverse score line 174. In turn, the rear hanging panel 172 is separated from the back panel 120 by a transverse score line 156. To form the hanging flap 168, the front hanging panel 170 is folded toward the front of the box 110 along transverse score line 174. Since the front hanging flap 170 is longer than rear hanging flap 172, a lower edge 176 of the front hanging panel 170 will then extend into the box 110 past the transverse score line 156. Thus, when the locking flap 158 is inserted into the box 110, to close the box 110, it also locks front hanging panel 170 into place, creating a double-ply hanging flap 168. To hang the box, the front and rear hanging panels 170, 172 may include slots 178, 180 that line up when the hanging flap 168 is formed. The slots 178, 180 then receive a hanger. Of course, it is to be appreciated that although slots are described in the exemplary embodiment, many types of apertures could be used while keeping within the scope and spirit of the invention. For example, a round aperture, or an elongated slot that extends to an edge of the flap is among the types of openings that could be used. These examples are not meant to limit the scope or spirit of the inventive concept. It is to be further appreciated that the box may be constructed with or without such hanging flaps.

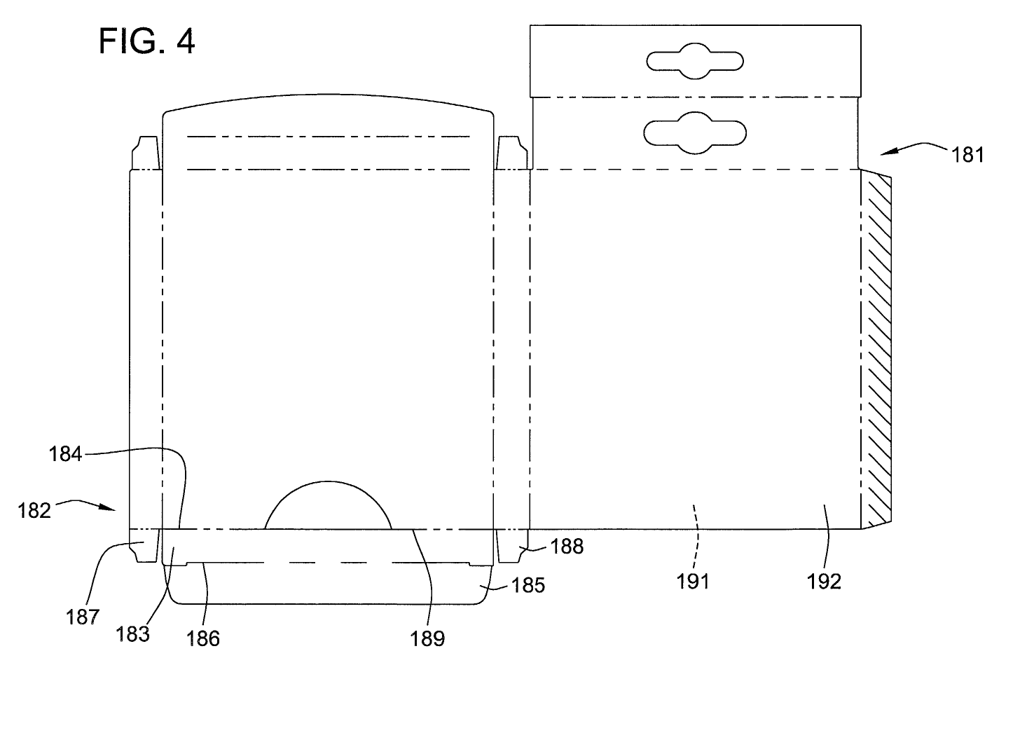

Additionally, as in another embodiment of the invention shown in FIG. 4, a die cut sheet 181 may be configured to provide an alternate method of closing the bottom end 182 of a substantially assembled box, as described above. In this embodiment, a bottom panel 183 is defined by transverse score line 184. The bottom panel 183 further includes a locking flap 185 and a transverse score line 186. To close the bottom end 182, lower locking flaps 187, 188 are first folded toward the interior of the box, along transverse score line 184. Then, the bottom panel 183 and locking flap 185 are folded toward the interior of the box along the transverse score lines 184, 186, respectively. Moreover, a bottom edge 189 is defined by a transverse score line 184 when the bottom panel 183 is folded in this fashion. The locking flap 185 is then inserted into the box, and is held closed by lower locking tabs 187, 188 and by abutting the back side 191 of the back panel 192.

Ultimately, as in the illustrative embodiments shown in FIGS. 2 and 13, when the box 110 is assembled, writing instruments can be arranged inside in various configurations. In one exemplary embodiment, shown in FIG. 2, a single row of writing instruments is contained within. However, as in another embodiment shown in FIG. 13, with slight modifications to the die cut sheet, a box 194 can be constructed for two rows 196, 198 of writing instruments. Moreover, the descriptions of the embodiments herein are not meant to limit the scope of the invention. A box configured to package a single writing instrument or any number of rows of writing instruments can be constructed in accordance with the teachings of the invention.

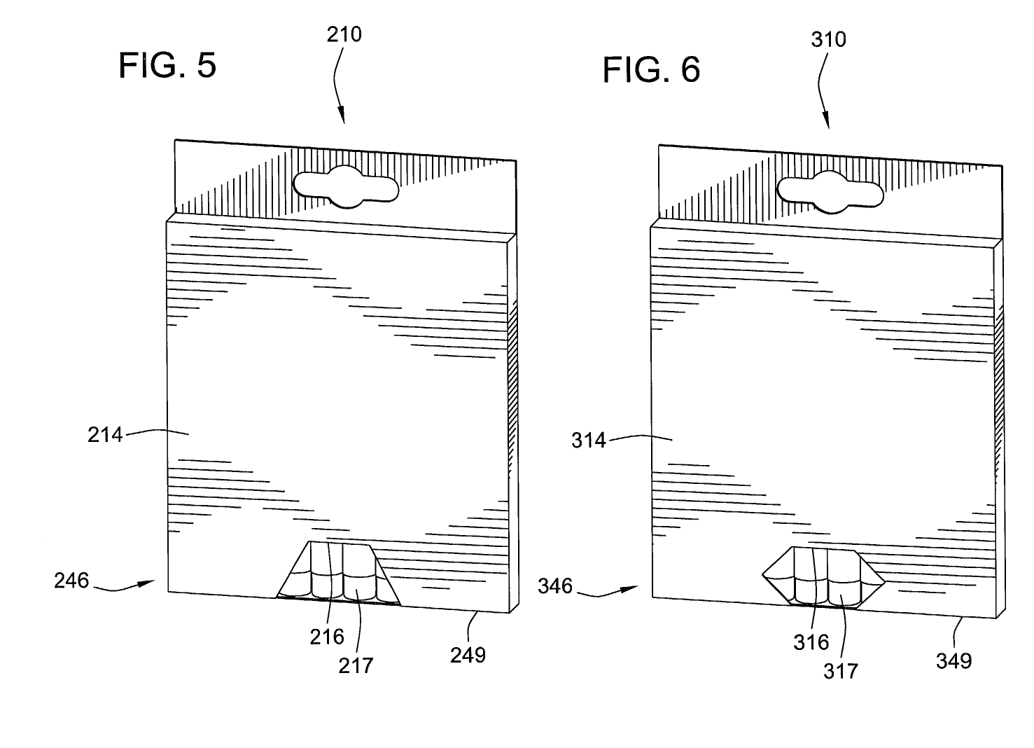

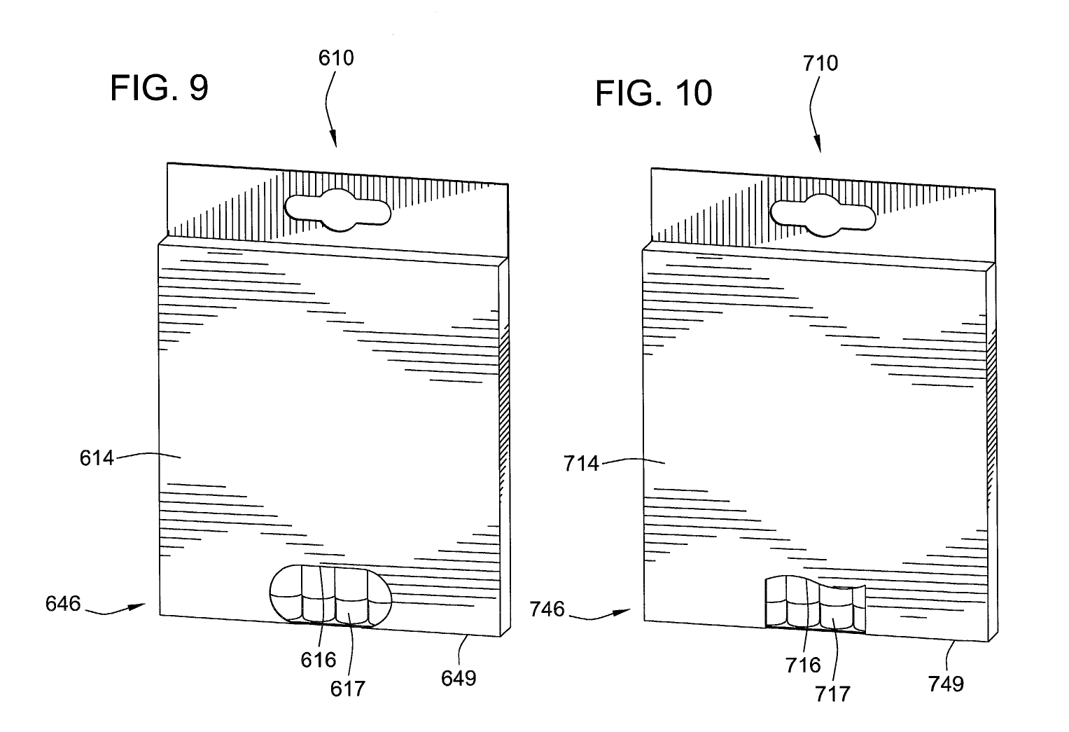

In other embodiments of the invention, as seen in FIGS. 5-11, the size and shape of the opening can be easily tailored to highlight special, unique attributes of the writing instruments contained within the box. For example, as shown in FIG. 5, a trapezoidal opening 216 is located at the bottom end 246 of box 210. In FIG. 6, a hexagonal opening 316 is located at the bottom end 346 of box 310. In FIG. 8, a truncated semicircular opening 516 is disposed at the bottom end 546 of box 510. FIG. 9 illustrates an obround opening 616 located at the bottom end 646 of box 610. In FIG. 10, a wave-shaped opening 716 is located at the bottom end 746 of box 710.

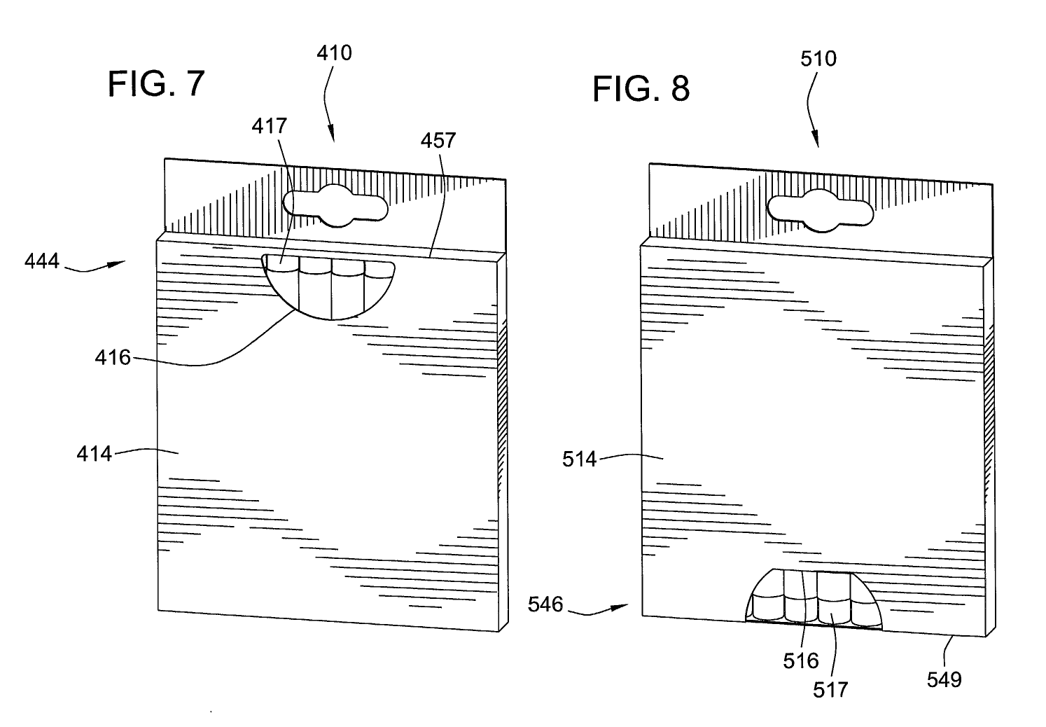

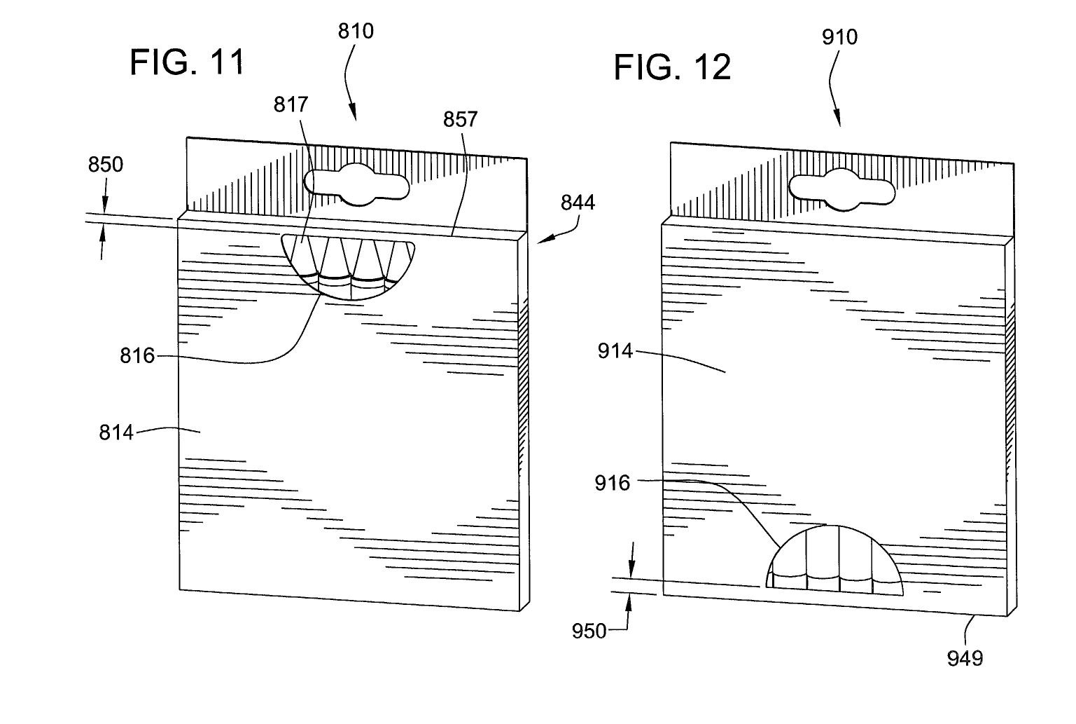

Additional embodiments of the invention, illustrated in FIGS. 7 and 11, may include openings 416, 816 located at the top ends 444, 844 of the respective boxes 410, 810 to facilitate direct viewing of attributes located at the corresponding ends of writing instruments packaged within.

As described above, these openings 216, 316, 416, 516, 616, 716, 816 can be disposed on the front panels 214, 314, 414, 514, 614, 714, 814 of the various embodiments described herein, adjacent to the top 457, 857 or bottom 249, 349, 549, 649, 749 edges. As described above, the openings 216, 316, 416, 516, 616, 716, 816 permit the display of attributes 217, 317, 417, 517, 617, 717, 817.

Moreover, the placement of an opening 116, 216, 316, 416, 516, 616, 716, 816 is not limited to the front panels 114, 214, 314, 414, 514, 614, 714, 814 of the various embodiments. Many embodiments may be contemplated within the scope of the inventive concept that include die cut openings 116, 216, 316, 416, 516, 616, 716, 816 disposed on any panel of the particular embodiment. For example, the opening may be disposed on the back panel 120, or the side panels 122, 124.

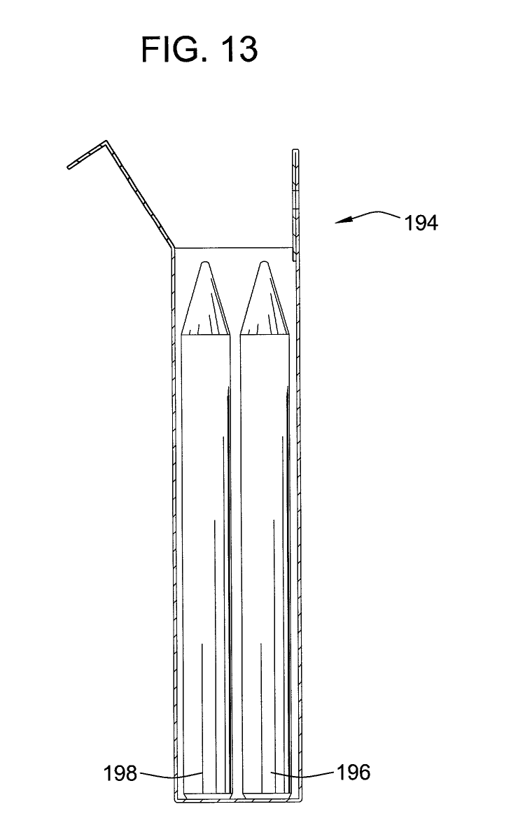

Another embodiment of the invention, shown in FIG. 12, illustrates an opening 916 on a front panel 914 of a box 910. The opening 916 of this embodiment may take the shape of the opening in one of the embodiments described above, or any other shape, without limiting the scope or inventive concept of the invention. The opening 916 is adjacent the bottom edge 949 of the front panel 914. In this embodiment the opening 916 is spaced from the bottom edge 949 by a dimension 950. The dimension 950 may be approximately ¼″ (6.4 mm) or less. Similarly, as shown in FIG. 11, the opening 816 may be adjacent the top edge 857 of the front panel 814. Specifically, the opening 816 may be spaced from the top edge 857 by a dimension 850. The dimension 850 may be approximately ¼″ (6.4 mm) or less. However, without restricting the scope or spirit of the invention, each of these dimensions 850, 950 may be any distance, limited only by the capabilities of the die cut processing method.

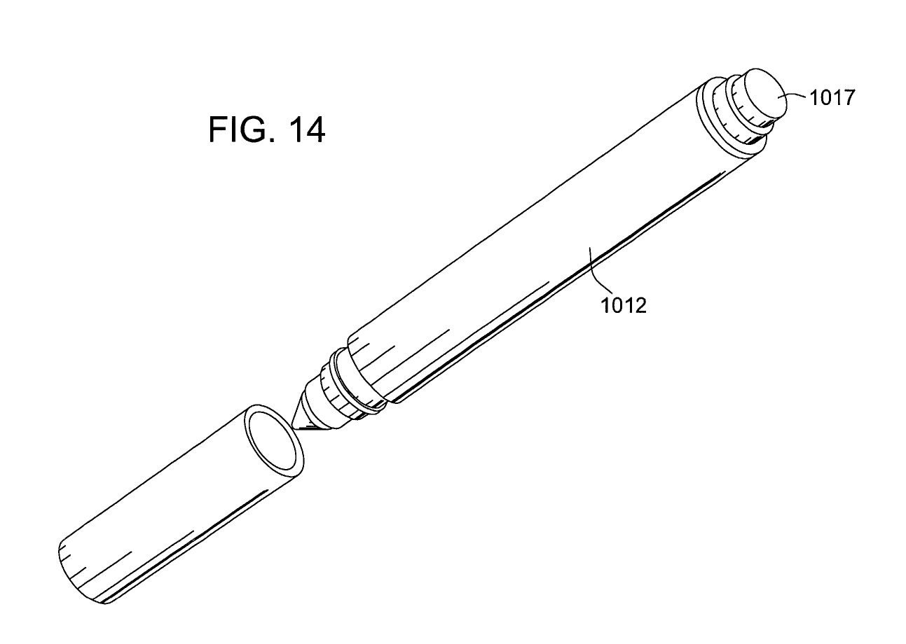

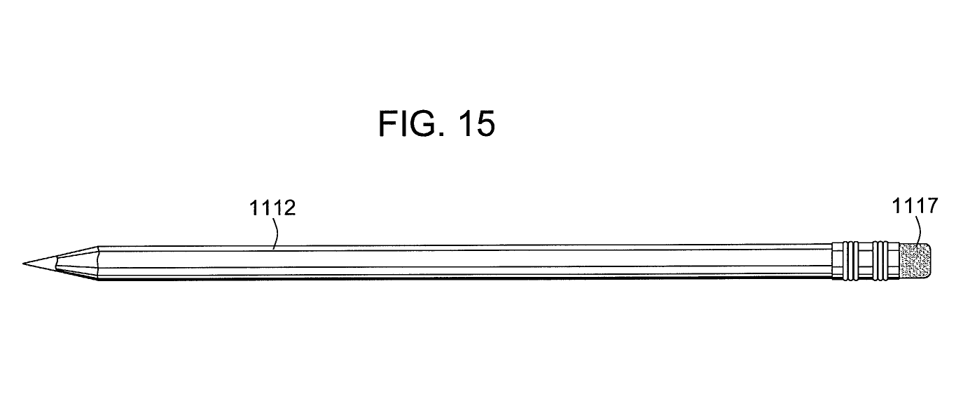

The particular attribute of the writing instruments to be directly displayed may include an eraser, a particularly detailed marker cap or plug, a specially shaped marker nib visible through a clear cap, or a toy or novelty on the end of a crayon, marker or pencil. For example, FIG. 1 shows an attribute 117, which is an eraser on the end of the writing instrument 112, which is a crayon. As illustrated in FIG. 14, the writing instrument may be a marker 1012, wherein the attribute 1017 is an eraser on the end of the marker 1012. Additionally, as shown in FIG. 15, the writing instrument may be a pencil 1112 wherein the attribute is an eraser 1117 on the end of the pencil 1112.

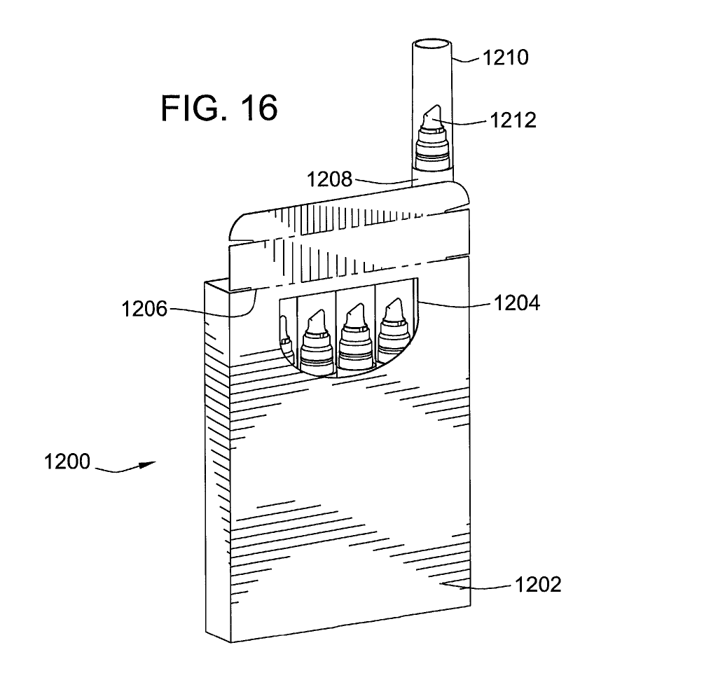

FIG. 16 depicts another embodiment of the invention wherein a box 1200, with a front panel 1202, according to the teachings of the invention, includes a partially obround opening 1204 disposed adjacent the top edge 1206 of the front panel 1202. Although the box of this embodiment does not include the hanging flaps of embodiments described earlier, it is to be appreciated that such hanging flaps may be added in another embodiment, without departing from the inventive concept. Further, the writing instrument contained within the box 1200 of this embodiment, or any other embodiment contemplated within the scope of the invention, may be a marker 1208 with a clear cap 1210. The clear cap 1210 may facilitate viewing of the marker nib 1212.

The attribute disposed on a writing instrument may also include an electronic device that moves or makes sounds, a chemical reservoir for erasability or a unique writing technique, a motorized, vibrating eraser, or a unique point on a crayon, marker or pencil. Additionally, the writing instrument is not limited to the types described herein.

While this invention has been described with an emphasis upon exemplary embodiments, variations of the exemplary embodiments can be used, and it is intended that the invention can be practiced otherwise than as specifically described herein. Accordingly, this invention includes all modifications encompassed within the spirit and scope of the invention as defined by the claims.

What is claimed is:

1. A box for displaying a particular attribute of a writing instrument contained within the box, wherein the attribute is on the end of the writing instrument, the box comprising:
a panel, the panel including an edge, the panel further including an opening, wherein the opening permits the attribute of the writing instrument to be visible from outside of the box.

2. The box of claim 1, wherein the edge is a bottom edge of the panel.

3. The box of claim 2, wherein the opening is adjacent the bottom edge.

4. The box of claim 3, wherein the opening is within approximately ¼″ (6.4 mm) of the bottom edge of the panel.

5. The box of claim 4, wherein the opening is on the bottom edge of the panel.

6. The box of claim 1, wherein the edge is a top edge of the panel.

7. The box of claim 6, wherein the opening is adjacent the bottom edge.

8. The box of claim 7, wherein the opening is within approximately ¼″ (6.4 mm) of the top edge of the panel.

9. The box of claim 8, wherein the opening is on the top edge of the panel.

10. The box of claim 1, wherein the opening is shaped as one of the group consisting of: a semicircle, a trapezoid, a hexagon, a truncated semicircle, an obround, a partial obround, or a wave shape.

11. The box of claim 1, wherein the box is constructed of a sheet of foldable material.

12. The box of claim 11, wherein the sheet of foldable material is scored before assembly of the box, to define fold lines and sealing flaps used in assembling the box.

13. The box of claim 12, wherein the sealing flaps are glued to other parts of the sheet to form the box.

14. The box of claim 11, wherein the foldable material is paperboard.

15. The box of claim 1, wherein the box further includes a hanging panel for hanging the box, the hanging panel further including an aperture.

16. The box of claim 1, the box further comprising:
a second panel, the second panel including an edge, the second panel further including an opening adjacent the edge of the second panel.

17. A combination of a box and a writing instrument contained within, wherein the writing instrument has an attribute, the box further comprising:
a panel, the panel including an edge, the panel further including an opening, wherein the opening permits the attribute of a writing instrument to be visible from outside of the box.

18. The combination as in claim 17, wherein the writing instrument is a crayon and the attribute is an eraser.

19. The combination as in claim 17, wherein the writing instrument is a marker and the attribute is an eraser.

20. The combination as in claim 17, wherein the writing instrument is a pencil and the attribute is an eraser.

21. The combination as in claim 17, wherein the edge is a bottom edge of the panel.

22. The combination as in claim 21, wherein the opening is adjacent the bottom edge.

23. The combination as in claim 22, wherein the opening is within approximately ¼″ (6.4 mm) of the bottom edge of the panel.

24. The combination as in claim 23, wherein the opening is on the bottom edge of the panel.

25. The combination as in claim 17, wherein the edge is a top edge of the panel.

26. The combination as in claim 25, wherein the opening is adjacent the top edge.

27. The combination as in claim 26, wherein the opening is within approximately ¼″ (6.4 mm) of the top edge of the panel.

28. The combination as in claim 27, wherein the opening is on the top edge of the panel.

29. The combination as in claim 17, wherein the opening is shaped as one of the group consisting of: a semicircle, a trapezoid, a hexagon, a truncated semicircle, an obround, a partial obround, or a wave shape.

30. The combination as in claim 17, wherein the attribute is one of the group consisting of: an eraser, a marker cap, a marker plug, an anti-roll device, a marker nib, a clear marker cap, a toy, a novelty, an electronic device, a chemical reservoir, a, vibrating eraser, a unique point on a crayon, or a point on a pencil.

31. The combination as in claim 17, wherein the box is constructed of a sheet of foldable material.

32. The combination as in claim 31, wherein the sheet of foldable material is scored before assembly, to define fold lines and sealing flaps used in assembling the box.

33. The combination as in claim 32, wherein the sealing flaps are glued to other parts of the sheet to form the box.

34. The combination as in claim 31, wherein the foldable material is paperboard.

35. The combination as in claim 17, wherein the box further includes a hanging panel for hanging the box, the hanging panel further including an aperture.

36. The combination as in claim 17, the box further comprising:
a second panel, the second back panel including an edge, the second panel further including an opening adjacent the edge of the second panel.
